(19) United States
(12) Patent Application Publication
(10) Pub. No.: US 2002/0097862 A1
(43) Pub. Date: Jul. 25, 2002

(54) VoDSL telephony solution

(76) Inventor: Uzi Shvadron, Ridgefield, CT (US)

Correspondence Address: McGuire Woods, LLP, Tysons Corner, Suite 1800, 1750 Tysons Boulevard, McLean, VA, 22102-3915, US

(21) Appl. No.: 09/768,558

(22) Filed: Jan. 25, 2001

(51) Int. Cl. H04M 1/00; H04M 9/00

(52) U.S. Cl. 379/399.01

(57) ABSTRACT

A Voice over DSL (VoDSL) solution allows an end user to buy and install off the shelf IAD (Integrated Access Device) devices for DSL (Digital Subscriber Loop) connection without the need for a technician. Each piece of equipment (telephone, facsimile, modem, computer) is provided with its own adapter which connects to the RJ11 wall connector without requiring rewiring the phone lines in the wall. The adapter enables the telephone equipment to be connected to the DSL link digitally and controlled by the IAD.

### BACKGROUND OF THE INVENTION

1. Field of the Invention

The present invention generally relates to telephony and, more particularly, to a solution to connect home or SOHO (Small Office, Home Office) telephony equipment and the IAD (Integrated Access Device) used for a DSL (Digital Subscriber Loop) connection.

2. Background Description

The widening availability of higher bandwidth and low-latency performance capabilities of broad-band network connections, such as DSL (Digital Subscriber Loop), have made the provision of voice-over-broad-band an increasingly attractive service offering. An integrated communications provider has the ability to offer customers multiple voice lines over a single DSL connection. This greatly leverages the provider's competitive position by packing more service capacity across the “last mile”. A single DSL connection enables tens of parallel voice lines plus high speed Internet access. It is now possible to cost-effectively address the needs of the huge market of small and medium sized businesses and also those of the home market.

Consider the current installation of telephony equipment at home or in a SOHO that allows access to the PSTN (Public Switched Telephone Network). At home, in most cases, several phones are connected to the same line. At the SOHO, the situation might be similar or there might be a small PBX (Private Branch exchange) used to distribute the calls. In most cases, the telephony equipment is scattered around several rooms or floors and is connected to phone lines within the walls. Also, in many cases, more than one line is connected to the same premises. Now the following question is raised—how to connect all the existing telephony equipment to an IAD that provides DSL connection to the broad-band network.

Current installation procedure requires a technician on site in order to install a DSL IAD with Voice-over-DSL (VoDSL) feature. Several changes to the phone wiring must be made. Such changes will take place every time a new equipment is to be connected to the IAD. Also, according to law, a “life-line” telephone must be connected as well for security reasons. The installation is a costly operation which increases the total cost of such DSL solutions.

Existing solutions offer several different techniques for the connection of telephony equipment to the IAD of the DSL connection. The simplest solution is to connect the telephones directly to the IAD. As discussed above, this will require (in most cases) a rewiring of some of the phone wires within the premises. This is not desirable and can be expensive. Another solution is the wireless one. In most cases, this solution will require new telephony equipment and wireless equipment at the IAD side. Facsimile services can hardly be provided over a wireless connection.

Another available solution is the Home Phone line Networking which has been implemented by several companies already. This is a computer network that uses digital communication methods such as Ethernet. The disadvantage of such a system is that phone lines at home are connected to the Ethernet side of the IAD using special equipment. All the phones that use the network must be Ethernet phones (Voice over IP phones). These are different from the existing equipment and are rather expensive. An adapter between a regular phone and the Ethernet network might be suggested as well, but this will be more complex and expensive. The connection to the Ethernet side of the IAD suffers from another problem, and that is it is difficult to provide for emergency situations (e.g., when the phones must operate over a PSTN network).

One more solution is to use the connections of the power lines at the premises. Again, new and more complex equipment needs to be added. Privacy needs to be addressed, preventing access from close by neighbors. The emergency situation must have a solution as well.

### SUMMARY OF THE INVENTION

It is therefore an object of the present invention to provide a solution that enables the installation of a DSL IAD without requiring a technician.

It is another object of the invention to provide a way to connect existing telephones in the customer premises to an IAD without making any physical changes in the existing telephone wiring.

According to the invention, the solution provided is based on the addition of a simple adapter to each existing telephony equipment. The adapter enables the telephone equipment to be connected to the DSL link digitally. The communication method using the wired telephone network in the premises is limited to a defined band above the DSL spectrum. In order to enable voice transmission in this band, a small adapter is added to each line connecting the telephony equipment (telephone, facsimile, modem). This small adapter resides in between the RJ11 wall connection and the telephone (or facsimile, modem). The IAD will have an additional functionality of handling the communication in this band as well.

The transmission method between the IAD and the adapters is kept simple. A preferred embodiment of the invention is based on existing, off the shelf, technology to achieve a low cost. This solution is based on a simple modulation approach using 16QAM (Quadrature Amplitude Modulation) for two channels—one to the IAD and one from the IAD. Each telephony device is assigned to its own time slot in which voice data is transmitted in a burst mode. One slot is devoted to each direction—to and from the IAD—in the two separated channels. The voice data is transmitted in Pulse Code Modulation (PCM); either μLaw or aLaw, depending of location, 8 bits/sample at 8K samples/second or 16K samples/second (for better voice quality). It is also possible to compress the voice. One slot (in each direction) is devoted to control data, and the IAD controls this slot. This slot enables the IAD to communicate with each adapter separately. The exact protocol for this control channel is not important to the practice of the invention.

The number of telephones supported by the system depends mainly on the DSL uplink type and can vary. In most cases, 128K bits/second (bps) are guaranteed for the upstream link. With a compression method like G.723 (6.4K bps), up to twenty telephone calls can be supported at the same time. This is more than enough for most of the market. Note that such a compression/decompression occurs (only if applicable) at the IAD on the DSL link.

This solution enables the customer to buy the DSL equipment off the shelf, connect it to a line at any location in the house or SOHO, and have all the telephones and facsimile machines (that have been connected to this line) work over the DSL connection. In addition, computers that have been connected before through a modem to this line would now have a fast DSL connection over the same line. All this can be installed by the customer—no need for a technician, no need for rewiring. This solution may actually convert the IAD into a small PBX for voice, modem and facsimile applications.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a pictorial representation of a small or home office telephony installation connected to a PSTN;

FIG. 2 is a pictorial representation of the small or home office telephony installation of FIG. 1 with the addition of an IAD and adapters for each of the telephony equipment (phone, modem, facsimile);

FIG. 3 is a graph illustrating the communications spectrum for DSL; and

FIG. 4 is a block diagram illustrating the adapter for each of the telephony equipment shown in FIG. 2.

### DETAILED DESCRIPTION OF A PREFERRED EMBODIMENT OF THE INVENTION

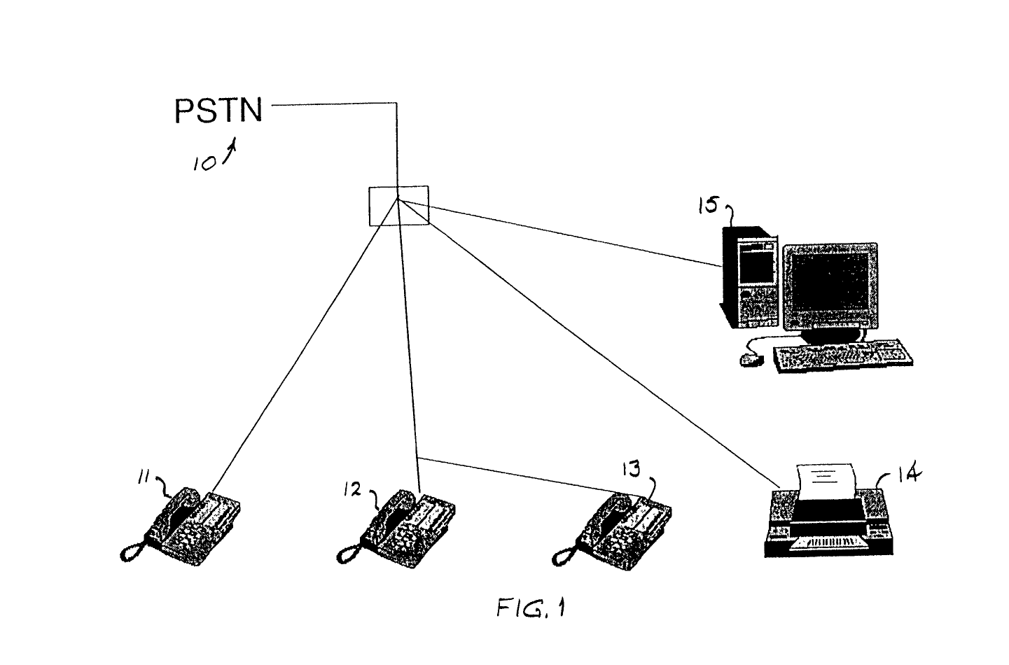

Referring now to the drawings, and more particularly to FIG. 1, there is shown a constellation of one line with several phones connected to it and one or two computers that are using the same line with a modem connection. In the specific example shown in FIG. 1, three telephones 11, 12 and 13 are connected to the PSTN 10, as are a facsimile machine 14 and a personal computer 15 (via an internal modem). This is a typical situation at home or in a small office (home office). As can be seen, the phone lines create a physical network—the main idea behind the solution according to this invention is to create a “digital voice and data network” based on this existing network of copper lines in the premises. Although the use of telephone lines for computer home network (such as HomePNA) is already known, the integration of the existing telephony equipment into such a network is new. Other voice connection methods for DSL uses wireless communications to the IAD or add special telephony equipment, such as Voice over IP digital telephones. The uniqueness of the present solution is the use of existing telephony equipment without modification.

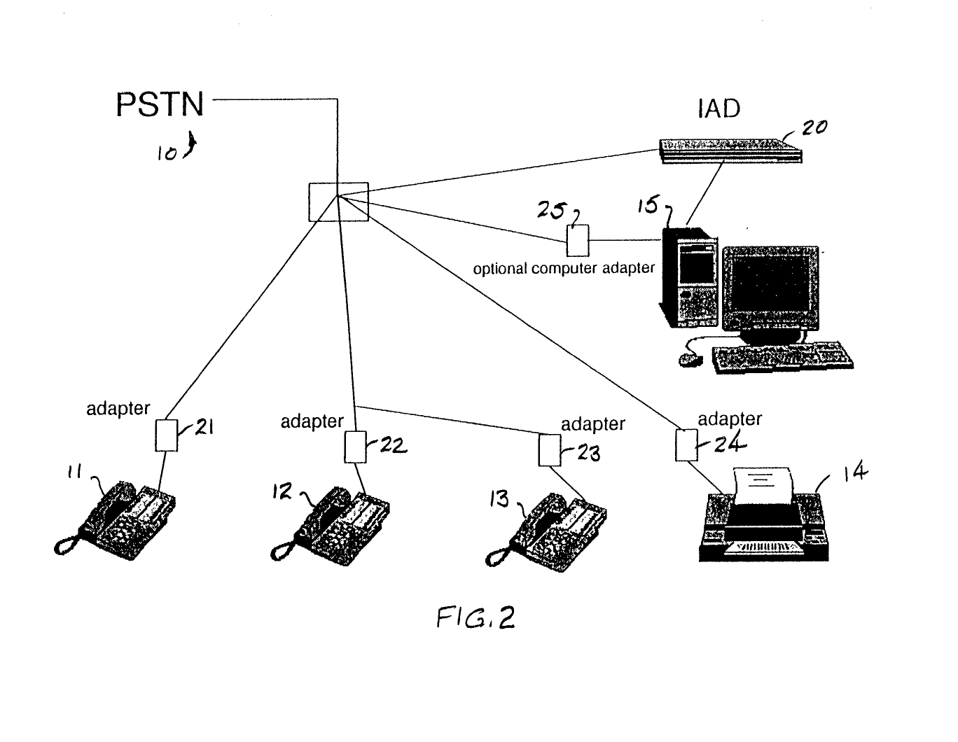

The communication method using the wired telephone network in the premises is limited to a defined band above the DSL spectrum. As shown in FIG. 2, in order to enable voice transmission in this band, a small adapter 21 to 25 is added to each line connecting the telephony equipment (telephone, facsimile, modem) 11 to 15. This small adapter resides in between the RJ11 wall connection and the telephone (or facsimile, modem). The IAD 20 will have an additional functionality of handling the communication in this band as described below.

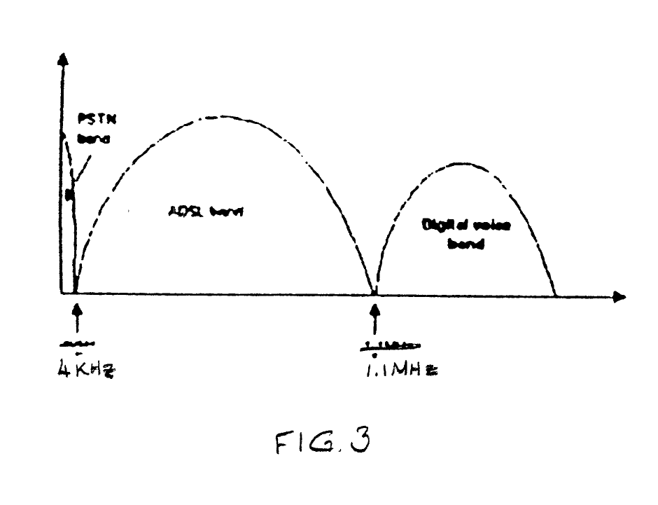

FIG. 3 illustrates the communications spectrum for DSL. The PSTN band occupies the first 4 KHz of the band. The ADSL (Asymmetric Digital Subscriber Line) band extends from 4 KHz to 1.1 MHZ. The digital voice band is that band above 1.1 MHZ in the spectrum. The LID 20 communicates with the adapters 21 to 25 in the digital voice band. When other methods of broadband are used (such as VDSL (Very-high-data-rate DSL)), the digital voice band will move to a location above it.

The transmission method between the IAD 20 and the adapters 21 to 25 should be kept simple. The following outlines one (but not necessarily the only) preferred embodiment. It is based on existing, off the shelf, technology so one can expect a low cost. This solution is based on a simple modulation approach using 16QAM (Quadrature Amplitude Modulation) for two channels —one to the IAD and one from the IAD. Each telephony device is assigned to its own time slot in which voice data is transmitted in a burst mode. One slot is devoted to each direction—to and from the IAD—in the two separated channels. an alternative method might be a multi-tone approach (e.g., FDM (Frequency Division Multiplexing)). This method is more complex to implement in the case where multiple sources of signals need to be combined.

The voice data is transmitted in Pulse Code Modulation (PCM): μLaw or aLaw—8 bits/sample at 8K samples/second or 16K samples/second (for better voice quality). It is also possible to compress the voice. One slot (in each direction) is devoted to control data, and the IAD 20 controls this slot. This slot enables the IAD 20 to communicate with each adapter 21 to 25 separately.

The number of telephones supported by the system depends mainly on the DSL uplink type and can vary. In most cases, 128K bits/second (bps) are guaranteed for the upstream link. With a compression method like G.723 (6.4K bps), up to twenty telephone calls can be supported at the same time.

This is more than enough for most of the market. Note that such a compression/decompression occurs (only if applicable) at the IAD on the DSL link. The following outlines the QAM structure for eight time slots—seven for telephony units and one for control. Nevertheless, other structures can be devised along the same lines. At 8K samples/second where each sample consists of eight bits (μLaw or aLaw), 64K bps are needed for each telephony unit. Using a constellation of 16QAM, 16K symbols/second are streamed for each unit. Since a total of eight slots are needed, 128K symbols/second are streamed in each direction. The burst length is protocol dependent, but it should be kept small in order to prevent long delays. When sampling at 16K samples/second for higher quality, two slots will be used by each adapter. Up to three such calls can be handled at the same time.

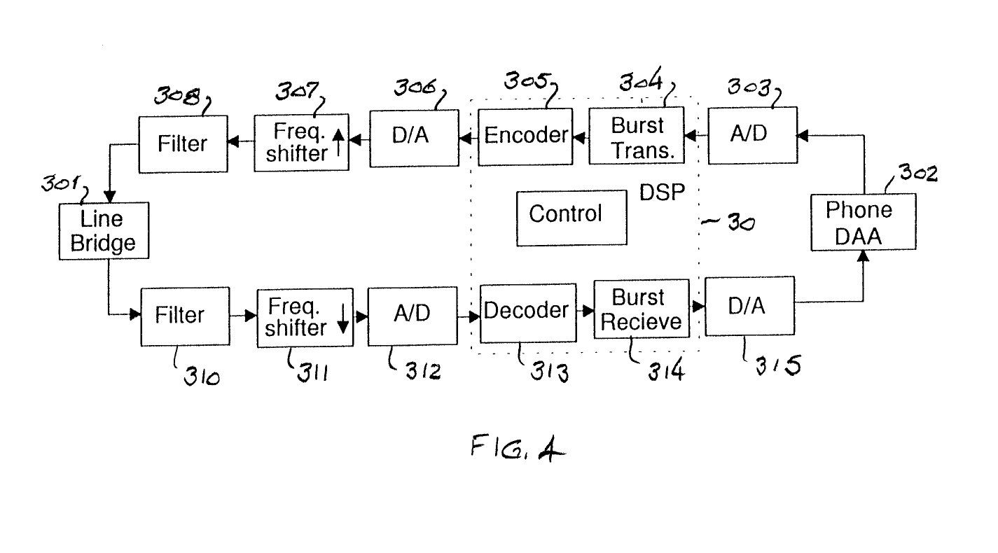

FIG. 4 illustrates the general structure of the adapter. The line bridge 301 makes the connection to the RJ11 wall connection, while the phone DAA (Digital Access Arrangement) 302 makes the connection to the telephony equipment. Starting from the DAA 302, the analog signal from the telephony equipment is sampled and buffered by analog-to-digital (A/D) converter 303 for burst transfer by a Digital Signal Processor (DSP) 30. The DSP 30 includes a burst transmitter 304 which receives the digital signal from the A/D converter 303 and provides an output to an encoder 305 which produces the digital QAM symbols. The output of the encoder 305 (and the DSP 30) is input to a digital-to-analog (D/A) converter 306, and the resulting analog signal is subjected to a up shift in frequency by frequency shifter 307 into the digital voice band (see FIG. 3). This signal is filtered by filter 308 before going out on the telephone line via line bridge 301 to the IAD 20.

An incoming signal received by the line bridge 301 is first filtered in filter 310 in order to extract the digital voice band which is then subjected to a down shift to base band in frequency shifter 311. The output of frequency shifter 311 is converted to the digital domain by A/D converter 312 to provide a digital signal input to DSP 30. The input digital signal is decoded in decoder 313 and then input to a burst receiver 314. The output of the burst receiver 314 (and the DSP 30) is then converted to an analog signal by D/A converter 315, which outputs an analog signal to the phone DAA 302. The control logic 316 of the DSP 30 monitors the line and synchronizes the bursts of incoming and outgoing symbols. The control logic 316 enables the IAD 20 to control each adapter through the information being sent during the control slot and acknowledges the information received for that adapter.

During regular operation, the control channel will be used to indicate ringing, off/on hook, and other signals between the phone and the IAD. Any proprietary protocol can be used between the IAD and the adapters. This protocol uses the control slots (in both directions) and should cover the adapter hookup to the IAD, the type of data to be transmitted, the needed signaling of calls, the dialing information, and additional signaling to the IAD for different services (which might be, for example, call transfer, add a party, hold, and other such services). Those skilled in the art will be able to devise a suitable protocol for specific applications.

The IAD handles the calls in a standard way according to the “Requirements for Voice over DSL” published in the DSL Forum WT-043. The LAD would then distribute the calls to the connected telephones (or facsimile machines) using the method described above. This turns the IAD into a PBX. This PBX can be controlled by an attached computer.

When an adapter is not transmitting, it would produce zero voltage with high impedance (similar to a 10 Base-T structure). The above can be realized by using one low power DSP. It is assumed that the power consumption of the adapter will be smaller than a conventional phone and that the service provider equipment (the DSLAM (Digital Subscriber Line Access Multiplexer)) is set to support this power consumption. In any case, power may be provided by the IAD as well.

The adapter should provide ringing capability either by driving the telephone or by producing its own ringing. It is important to note that when the network is not operational (for any reason), the adapter automatically enables analog connection to the PSTN from any phone.

While the invention has been described in terms of a single preferred embodiment, those skilled in the art will recognize that the invention can be practiced with modification within the spirit and scope of the appended claims.

Having thus described our invention, what we claim as new and desire to secure by letters patent is as follows:

1. An adapter for enabling existing telephone equipment to be connected to a Digital Subscriber Loop (DSL) link, the adapter being connected between a telephone equipment and existing telephone wiring and communicating with an Integrated Access Device (IAD) digitally, the IAD being connected to the existing telephone wiring and controlling communications with each adapter.

2. The adapter recited in claim 1, wherein each adapter is assigned its own slot in which data is transmitted and an additional slot, controlled by the IAD, is devoted to control data.

3. The adapter recited in claim 2, wherein the slots assigned to the adapter and the IAD are time slots.

4. The adapter recited in claim 2, wherein communication using the existing wiring is above a spectrum assigned to DSL, the adapter including frequency shifters for shifting frequencies of transmitted and received signals.

5. The adapter recited in claim 2, wherein voice data is transmitted using Pulse Code Modulation (PCM).

6. The adapter recited in claim 2, further comprising:
line bridge making a connection to the existing telephone wiring;
phone Digital Access Arrangement( DAA) making a connection to the telephone equipment;
a first analog-to-digital (A/D) converter connected to the DAA, an analog signal from the telephone equipment being sampled and buffered by the first A/D converter to produce a digital signal;
an encoder connected to receive an output signal from the first A/D converter and providing an encoded output;
a first digital-to-analog (D/A) converter connected to the encoder and generating an analog signal;
a first frequency shifter connected to the first D/A converter shifting the analog signal into a digital voice band;
a first filter connected between the first frequency shifter and the line bridge for filtering the shifted analog signal before going out on the telephone line via line;
a second filter connected to the line bridge for filtering an incoming analog signal from the line bridge in order to extract a digital voice band signal;
a second frequency shifter connected to the second filter for down shifting the filtered signal to base band;
a second A/D converter connected to the second frequency shifter converting shifted signal to a digital domain;
a decoder connected to the second A/D converter for decoding the converted signal; and
a second D/A converter connected between the decoder and the DAA for converting the digital signal to an analog signal supplied to the telephone equipment.

7. The adapter recited in claim 6, further comprising:
a burst transmitter connected to receive the digital signal from the A/D converter and supply an output to the encoder; and
a burst receiver connected to the decoder and providing an output to the second D/A converter.

8. The adapter recited in claim 7, wherein the burst transceiver, the encoder, the decoder, and the burst receiver are implemented in a Digital Signal Processor (DSP), the DSP including control logic which monitors the line and synchronizes bursts of incoming and outgoing symbols.

9. The adapter recited in claim 8, wherein the control logic enables the IAD to control each adapter through information sent during the control slot and acknowledges information received for the adapter.

10. The adapter recited in claim 7, wherein the encoder produces the digital Quadrature Amplitude Modulation (QAM) symbols and the decoder decodes QAM symbols.
